(19) United States
(12) Patent Application Publication
(10) Pub. No.: US 2025/0349018 A1
(43) Pub. Date: Nov. 13, 2025

(54) DEPTH ESTIMATION SYSTEM AND METHOD THEREOF

(71) Applicant: LITE-ON TECHNOLOGY CORPORATION, TAIPEI CITY (TW)

(72) Inventors: Tzu Chia LIU, TAIPEI CITY (TW); Chih-Yuan CHUANG, TAIPEI CITY (TW); Chuen Ning HSU, TAIPEI CITY (TW); Jiun-Shiung CHEN, TAIPEI CITY (TW)

(21) Appl. No.: 19/050,295

(22) Filed: Feb. 11, 2025

Related U.S. Application Data
(60) Provisional application No. 63/645,979, filed on May 13, 2024.
(60) Provisional application No. 63/689,901, filed on Sep. 3, 2024.

(51) Int. Cl. G06T 7/543; B60H 1/00; B60K 35/21; B60Q 9/00; B60R 16/037; B60R 21/015; G06T 3/14; G06T 3/40; G06T 3/60; G06T 5/80; G06T 7/33

(52) U.S. Cl. CPC G06T 7/543; B60H 1/00742; G06T 3/14; G06T 3/40; G06T 3/60; G06T 5/80; G06T 7/337; B60K 35/21; B60Q 9/00; B60R 16/037; B60R 21/01538; G06T 2207/10024; G06T 2207/30201; G06T 2207/30268

(57) ABSTRACT

A depth estimation system is provided. The depth estimation system includes a pinhole camera, a fisheye camera, and a processing circuitry. The pinhole camera is configured to capture a narrow-view image of an entity. The fisheye camera is configured to capture a wide-view image of the entity. An orientation deviation and a position offset are present between the pinhole camera and the fisheye camera. The processing circuitry is configured to downscale the narrow-view image to generate a resized image, rotate the wide-view image using a rotation compensation parameter that is determined based on the orientation deviation to generate a rotated image, determine pixel mapping information between the rotated image and the resized image based on an epipolar constraint, and estimate depth information of the entity relative to the pinhole camera based on the pixel mapping information and the position offset.

### CROSS REFERENCE TO RELATED APPLICATIONS

This application claims the benefit of U.S. Provisional Application No. 63/645,979, filed May 13, 2024, and U.S. Provisional Application No. 63/689,901, filed Sep. 3, 2024, the entirety of which are incorporated by reference herein.

### BACKGROUND OF THE INVENTION

### Field of the Invention

The present invention relates to image analysis, and, in particular, to a depth estimation system and method thereof.

### Description of the Related Art

Depth estimation is a critical technology used in a variety of fields, including autonomous driving, driver assistance systems, robotics, and augmented reality. Accurate depth information allows systems to perceive the three-dimensional structure of a scene, enabling applications such as obstacle avoidance, spatial navigation, and object tracking. Depth estimation systems typically use cameras to extract disparity or mapping information between images captured from different viewpoints, and subsequently apply optical geometry to calculate the corresponding 3D information in space.

In traditional depth estimation systems using stereoscopic cameras, both cameras are typically identical in type and share an overlapping field of view (FoV). For example, two pinhole cameras or two fisheye cameras may be mounted in parallel to simplify the depth computation process. These systems rely on well-calibrated configurations where the cameras are nearly coplanar and rotationally aligned. However, the strict alignment requirements often limit flexibility in camera placement, particularly in environments where constraints on installation space or angles exist.

For instance, in an automotive cabin application, depth estimation systems can be used to monitor the position of occupants, such as the driver or passengers, to improve safety and enhance driver assistance features. In this scenario, the overlapping FoV of the cameras is used to extract depth information of objects or individuals within the cabin. However, relying on identical cameras with strictly aligned configurations can be challenging due to design and space limitations within the cabin.

Recent implementations use a pinhole camera and a fisheye camera separately to serve different functional purposes rather than depth estimation. For instance, in an automotive cabin application, the pinhole camera may be used for Driver Monitoring Systems (DMS), focusing on capturing high-resolution, narrow-view images of the driver's facial features, while the fisheye camera is used in Occupant Monitoring Systems (OMS) to provide wide-view coverage of the entire cabin for occupant detection or activity monitoring.

While such heterogeneous camera configurations are commonly implemented in modern systems for distinct applications, their use for depth estimation is not straightforward. The inherent differences of heterogeneous cameras pose significant challenges for depth estimation. Specifically, unlike traditional stereoscopic camera setups that use identical cameras with overlapping fields of view (FoV) and well-aligned mounting, heterogeneous camera systems involve cameras with distinct FoVs, different optical characteristics, and are often mounted at separate positions with varying angles. These discrepancies introduce complex issues, such as non-overlapping imaging geometries, rotational and positional misalignments, and difficulties in establishing consistent pixel correspondences between the images.

Therefore, it is desirable to have a depth estimation system and method capable of using heterogeneous camera configurations to flexibly estimate depth information, while addressing challenges posed by the heterogeneous camera configurations.

### BRIEF SUMMARY OF THE INVENTION

An embodiment of the present invention provides a depth estimation system. The depth estimation system includes a pinhole camera, a fisheye camera, and a processing circuitry. The pinhole camera is configured to capture a narrow-view image of an entity. The fisheye camera is configured to capture a wide-view image of the entity. An orientation deviation and a position offset are present between the pinhole camera and the fisheye camera. The processing circuitry is configured to downscale the narrow-view image to generate a resized image, rotate the wide-view image using a rotation compensation parameter that is determined based on the orientation deviation to generate a rotated image, determine pixel mapping information between the rotated image and the resized image based on an epipolar constraint, and estimate depth information of the entity relative to the pinhole camera based on the pixel mapping information and the position offset.

In an embodiment, the epipolar constraint for each pixel of the resized image is determined based on the orientation deviation and the position offset, and is stored in a mapping table. The mapping table records the correspondence between each pixel of the resized image and the epipolar constraint. The processing circuitry is further configured to retrieve the epipolar constraint from the mapping table based on the correspondence recorded in the mapping table for each pixel of the resized image.

In an embodiment, the epipolar constraint is defined by a coefficient set of an epipolar line. The processing circuitry is further configured to determine the pixel mapping information between the rotated image and the resized image based on the epipolar constraint by extracting feature values for a target pixel of the resized image and a plurality of candidate pixels along the epipolar line in the rotated image, comparing the feature values of the target pixel with the feature values of the plurality of candidate pixels to determine a similarity score for each candidate pixel, and selecting one of the candidate pixels with the highest similarity score as the corresponding pixel of the target pixel, thereby determining a mapping between the target pixel and the corresponding pixel. The feature values are determined based on pixel intensity within a predefined neighborhood of each pixel.

In an embodiment, the processing circuitry is further configured to reduce the first scale of the narrow-view image to generate the resized image with the second scale that is substantially smaller than the first scale.

In an embodiment, the second scale is determined based on a comparison of the size of the entity in the wide-view image and the size of the entity in the narrow-view image. The entity in the wide-view image and the entity in the resized image are substantially equal in size.

In an embodiment, the processing circuitry is further configured to downscale the narrow-view image using a scaling factor. The scaling factor is determined based on focal lengths of the pinhole camera and the fisheye camera.

In an embodiment, the depth estimation system further includes a volatile memory. In the preliminary phase, the processing circuitry is further configured to allocate a first contiguous section of the volatile memory, and initialize the first contiguous section of the volatile memory with a predefined value. In the online phase, the processing circuitry is further configured to use the first contiguous section of the volatile memory to rotate the wide-view image.

In an embodiment, in the preliminary phase, the processing circuitry is further configured to allocate a second contiguous section, a third contiguous section, and a fourth contiguous section of the volatile memory. In the online phase, the processing circuitry is further configured to use the second continuous section of the volatile memory to downscale the narrow-view image, use the third continuous section of the volatile memory to determine the pixel mapping information, and use the fourth continuous section of the volatile memory to estimate the depth information of the entity relative to the pinhole camera.

In another embodiment, in the preliminary phase, the processing circuitry is configured to allocate a first contiguous section of the volatile memory, and initialize the first contiguous section of the volatile memory with a predefined value. In the online phase, the processing circuitry is further configured to use the first contiguous section of the volatile memory to store the wide-view image, use a first separate section of the volatile memory to rotate the wide-view image, and overwrite the wide-view image in the first contiguous section with the rotated image.

In another embodiment, in the preliminary phase, the processing circuitry is further configured to allocate a second contiguous section of the volatile memory. In the online phase, the processing circuitry is further configured to use the second contiguous section of the volatile memory to store the narrow-view image, use a second separate section of the volatile memory to downscale the narrow-view image to generate a resized image, and overwrite the narrow-view image in the second contiguous section with the resized image.

In an embodiment, the processing circuitry is further configured to use a first distortion coefficient set to correct distortion in the narrow-view image before downscaling the narrow-view image, and use a second distortion coefficient set to correct distortion in the wide-view image before rotating the wide-view image.

In an embodiment, the processing circuitry is further configured to align the color tones of the resized image and the rotated image by grayscaling the resized image and the rotated image.

In an embodiment, the orientation deviation is represented in one of the Euler angles format and the quaternion format.

In an embodiment, the processing circuitry is further configured to identify a target region in the rotated image, and determine the pixel mapping information between the target region and the resized image based on the epipolar constraint. The target region is an area containing the facial region of the entity within the rotated image.

In an embodiment, the processing circuitry is further configured to use the estimated depth information of the entity relative to the pinhole camera to adjust an operational parameter of an automotive control system. In a further embodiment, the automotive control system includes at least one of an eye tracking-based dashboard display system, a driver attention alert system, a steering wheel adjustment system, a seat position adjustment system, an air conditioning system, a heads-up display system, or an airbag deployment system.

An embodiment of the present invention provides a depth estimation method. The depth estimation method is executed by a processing circuitry to estimate depth information of an entity relative to a pinhole camera based on a narrow-view image and a wide-view image of an entity. The narrow-view image and the wide-view image are respectively captured by the pinhole camera and a fisheye camera. An orientation deviation and a position offset are present between the pinhole camera and the fisheye camera. The depth estimation method includes a step of downscaling the narrow-view image to generate a resized image, a step of rotating the wide-view image using a rotation compensation parameter that is determined based on the orientation deviation to generate a rotated image, a step of determining pixel mapping information between the rotated image and the resized image based on an epipolar constraint, and a step of estimating the depth information of the entity relative to the pinhole camera based on the pixel mapping information and the position offset.

In an embodiment, the epipolar constraint for each pixel of the resized image is determined based on the orientation deviation and the position offset, and is stored in a mapping table. The mapping table records the correspondence between each pixel of the resized image and the epipolar constraint. The step of determining the pixel mapping information further involves retrieving the epipolar constraint from the mapping table based on the correspondence recorded in the mapping table for each pixel of the resized image.

In an embodiment, the epipolar constraint is defined by a coefficient set of an epipolar line. The step of determining the pixel mapping information between the rotated image and the resized image based on the epipolar constraint further involves extracting feature values for a target pixel of the resized image and a plurality of candidate pixels along the epipolar line in the rotated image, comparing the feature values of the target pixel with the feature values of the plurality of candidate pixels to determine a similarity score for each candidate pixel, and selecting one of the candidate pixels with the highest similarity score as the corresponding pixel of the target pixel, thereby determining a mapping between the target pixel and the corresponding pixel.

In an embodiment, the step of downscaling the narrow-view image further involves reducing a first scale of the narrow-view image to generate the resized image with a second scale that is substantially smaller than the first scale.

In an embodiment, the second scale is determined based on a comparison of the size of the entity in the wide-view image and the size of the entity in the narrow-view image. The entity in the wide-view image and the entity in the resized image are substantially equal in size.

In an embodiment, the step of downscaling the narrow-view image further involves using a scaling factor to downscale the narrow-view image. The scaling factor is determined based on focal lengths of the pinhole camera and the fisheye camera.

In an embodiment, the depth estimation method further involves a preliminary phase and an online phase. In the preliminary phase, a first contiguous section of a volatile memory is allocated, and the first contiguous section of the volatile memory is initialized with a predefined value. In the online phase, the first contiguous section of the volatile memory is used to rotate the wide-view image.

In an embodiment, in the preliminary phase, a second contiguous section, a third contiguous section, and a fourth contiguous section of the volatile memory are allocated. In the online phase, the second continuous section of the volatile memory is used to downscale the narrow-view image, the third continuous section of the volatile memory is used to determine the pixel mapping information, and the fourth continuous section of the volatile memory is used to estimate the depth information of the entity relative to the pinhole camera.

In another embodiment, in the preliminary phase, the first contiguous section of the volatile memory is allocated, and the first contiguous section of the volatile memory is initialized with a predefined value. In the online phase, the first contiguous section of the volatile memory is used to store the wide-view image, a first separate section of the volatile memory is used to rotate the wide-view image, and the wide-view image is overwritten in the first contiguous section with the rotated image.

In another embodiment, in the preliminary phase, the second contiguous section of the volatile memory is allocated. In the online phase, the second contiguous section of the volatile memory is used to store the narrow-view image, a second separate section of the volatile memory is used to downscale the narrow-view image to generate a resized image, and the narrow-view image is overwritten in the second contiguous section with the resized image.

In an embodiment, the depth estimation further involves using a first distortion coefficient set to correct distortion in the narrow-view image before downscaling the narrow-view image, and using a second distortion coefficient set to correct distortion in the wide-view image before rotating the wide-view image.

In an embodiment, the depth estimation further involves aligning the color tones of the resized image and the rotated image by grayscaling the resized image and the rotated image.

In an embodiment, the orientation deviation is represented in one of a Euler angles format and a quaternion format.

In an embodiment, the depth estimation further involves identifying a target region in the rotated image, and determining the pixel mapping information between the target region and the resized image based on the epipolar constraint. The target region is an area containing the facial region of the entity within the rotated image.

In an embodiment, the depth estimation further involves using the estimated depth information of the entity relative to the pinhole camera to adjust an operational parameter of an automotive control system. In a further embodiment, the automotive control system includes at least one of an eye tracking-based dashboard display system, a driver attention alert system, a steering wheel adjustment system, a seat position adjustment system, an air conditioning system, a heads-up display system, or an airbag deployment system.

### BRIEF DESCRIPTION OF THE DRAWINGS

The present invention can be more fully understood by reading the subsequent detailed description and examples with references made to the accompanying drawings, wherein:

FIG. 1 is the schematic diagram of a depth estimation system, according to an embodiment of the present disclosure;

FIG. 2 is the schematic diagram illustrating the position offset and the orientation deviation between the pinhole camera and the fisheye camera, according to an embodiment of the present disclosure;

FIG. 3 is the flow diagram of the depth estimation method executed by the depth estimation system illustrated in FIG. 1, according to an embodiment of the present disclosure;

FIG. 4 is the schematic diagram illustrating operation of the Adaptive Mapping step, according to an embodiment of the present disclosure;

FIG. 5 is the schematic diagram illustrating operation of the Perspective Rotation Compensation step, according to an embodiment of the present disclosure;

FIG. 6A and FIG. 6B illustrate the process of deriving the rotation compensation parameter during an offline calibration phase, according to an embodiment of the present disclosure;

FIG. 7A is the flow diagram of the Scene Correspondence Calculation step, according to an embodiment of the present disclosure;

FIG. 7B is the schematic diagram of the Scene Correspondence Calculation step, according to an embodiment of the present disclosure;

FIG. 8 illustrates additional steps, any one or combination of which may be included in the depth estimation method shown in FIG. 3, according to various embodiments of the present disclosure; and

FIG. 9 is a schematic diagram of a mapping table, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

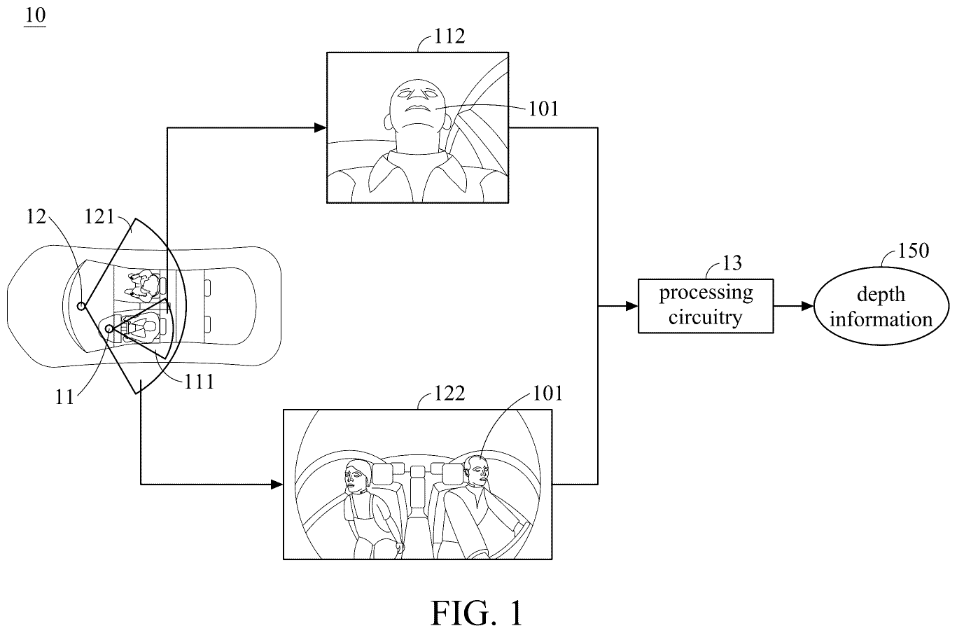

FIG. 1 is the schematic diagram of a depth estimation system 10, according to an embodiment of the present disclosure. As shown in FIG. 1, the depth estimation system 10 includes a pinhole camera 11, a fisheye camera 12, and a processing circuitry 13.

The pinhole camera 11 is a type of camera designed to capture high-resolution images with a narrow field of view, typically ranging from 50° to 70°. It is typically used for capturing detailed and focused images of a specific region or object.

The fisheye camera 12, in contrast, is designed to capture images with an extremely wide field of view, typically ranging from 180° to 220°. While the sensor resolution of fisheye camera images may be equal to that of pinhole camera images, a fisheye camera typically has a lower spatial resolution or pixel density compared to a pinhole camera. This is because the fisheye camera's wider Field of View (FoV) distributes the same number of pixels over a larger area, reducing the amount of detail captured per unit area. However, the pinhole camera provides higher spatial resolution due to its narrower FoV, which allows each pixel to capture more detail from a smaller portion of the scene. Consequently, the fisheye camera's wide field of view allows it to cover a significantly larger area in a single frame. This makes the fisheye camera 12 complementary to the pinhole camera 11, as the former captures a broader context while the latter provides higher detail in a more focused region of the same scene.

According to embodiments of the present disclosure, the pinhole camera 11 and the fisheye camera 12 are configured to capture a narrow-view image 112 and a wide-view image 122 of an entity 101, respectively. The narrow-view image 112 provides high-detail information about the entity 101, while the wide-view image 122 encompasses a broader scene, which may include additional contextual information about the entity 101 and its surroundings.

The processing circuitry 13 may be implemented by either a general-purpose processor or a dedicated hardware circuitry. In an embodiment where the processing circuitry 13 is implemented by a general-purpose processor, such as CPU, the processing circuitry 13 loads a program or an instruction set from a storage medium (though not shown in FIG. 1) to execute a depth estimation method. In another embodiment where the processing circuitry 13 is implemented by a dedicated hardware circuitry, such as an application-specific integrated circuit (ASIC) or field programmable gate array (FPGA), the processing circuitry 13 is configured or programmed to execute the corresponding steps of the depth estimation method.

The depth estimation method, executed by the processing circuitry 13, generally involves estimating depth information 150 of the entity 101 relative to the pinhole camera 11 based on the narrow-view image 112 and the wide-view image 122 of the entity 101. More details about the depth estimation method will be elaborated hereinafter.

The depth information 150 indicates the spatial distance between the entity 101 and the pinhole camera 11. It can take various forms, such as a depth map providing detailed distance information across the entire image, the distance to a specific feature of the entity 101 (e.g., eyes, nose, or other key points), and/or the closest point or distance between the entity and the camera, depending on various application demands, but the present disclosure is not limited thereto.

Although FIG. 1 illustrates an in-cabin application scenario where the entity 101 is a driver, it should be appreciated that this is merely an example rather than a limitation. Embodiments of the present disclosure are not limited to automotive applications and may be used in various environments and scenarios, including but not limited to robotics, surveillance, augmented reality, and medical imaging.

In an embodiment, the processing circuitry 13 is further configured to use the estimated depth information 150 of the entity 101 relative to the pinhole camera 11 to adjust an operational parameter of an automotive control system. The automotive control system includes at least one of an eye tracking-based dashboard display system, a driver attention alert (DAA) system, a steering wheel adjustment system, a seat position adjustment system, an air conditioning system, a heads-up display system, or an airbag deployment system.

Specifically, the estimated depth information 150 may be used to adjust the position or angle of the steering wheel to align with the driver's seating position, improving ergonomics and comfort. It can also be used to modify the seat position, such as moving it forward or backward, to ensure both safety and convenience for the driver or passengers. Additionally, the depth information 150 can be used to regulate the air conditioning system by directing airflow more effectively based on the occupant's location. For heads-up display systems, the depth information 150 can be used to calibrate the display position or adjust the content size to align with the driver's position and/or line of sight. Furthermore, in the event of a collision, the depth information 150 may be used to determine the appropriate airbag deployment force based on the proximity of the driver or passengers, thereby enhancing overall safety.

Moreover, the estimated depth information 150 can also be used to adjust operational parameters in the eye tracking-based dashboard display system and/or the driver attention alert system. In the eye tracking-based dashboard display system, the depth information 150 is used to determine the driver's head position and eye distance from the dashboard. Based on this information, the system can dynamically adjust the brightness, focal distance, and content scaling of the dashboard display. For example, if the driver is positioned further away, the system may increase the font size and brightness to maintain readability. Conversely, if the driver is closer, the system may reduce brightness to prevent glare and adjust the focus for optimal clarity. In the driver attention alert (DAA) system, the depth information 150 is used to monitor the driver's head position and movement patterns over time. If the depth information 150 indicates that the driver's head is consistently tilted downward or turned away from the road, the system can activate auditory warnings, visual alerts on the dashboard, or haptic feedback through the steering wheel or seat.

In practice, in addition to differences in optical characteristics, the pinhole camera 11 and the fisheye camera 12 are deployed at different locations and capture images from distinct viewpoints. In other words, a position offset and an orientation deviation are present between the pinhole camera 11 and the fisheye camera 12. The position offset and the orientation deviation represent the relative extrinsic parameters of the pinhole camera 11 and the fisheye camera 12. The presence of position offset and orientation deviation pose additional challenges for depth estimation.

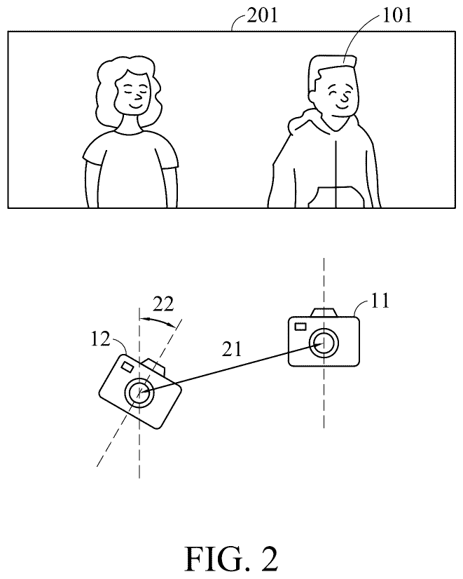

FIG. 2 is the schematic diagram illustrating the position offset 21 and the orientation deviation 22 between the pinhole camera 11 and the fisheye camera 12, according to an embodiment of the present disclosure. As shown in FIG. 2, the position offset 21 represents the spatial displacement between the pinhole camera 11 and the fisheye camera 12. This displacement indicates that the two cameras are mounted at distinct physical locations, which may result in differences in their captured perspectives of the scene 201, including the entity 101. The orientation deviation 22, on the other hand, denotes the angular misalignment between the optical axes of the pinhole camera 11 and the fisheye camera 12. This angular difference reflects that the cameras are pointed in slightly different directions, leading to variations in the field of view and the relative positioning of objects in their respective images.

Although FIG. 2 illustrates the position offset 21 and the orientation deviation 22 in two dimensions for simplicity, it should be noted that these discrepancies occur in a three-dimensional space. The position offset 21 may include displacements along the X, Y, and Z axes, representing differences in the cameras' physical placement, such as lateral shifts, vertical elevations, or forward/backward spacing. Similarly, the orientation deviation 22 may involve rotations around these axes, such as pitch, yaw, or roll, reflecting the angular misalignment between the cameras' optical axes.

In an embodiment, the orientation deviation 22 is represented in one of a Euler angles format and a quaternion format. The Euler angles format provides an intuitive way to describe the rotations around the three axes independently, making it straightforward to visualize each component of the angular misalignment. On the other hand, the quaternion format, widely used in three-dimensional spatial computation, offers advantages such as avoiding gimbal lock and enabling efficient mathematical transformations for aligning the images captured by the cameras.

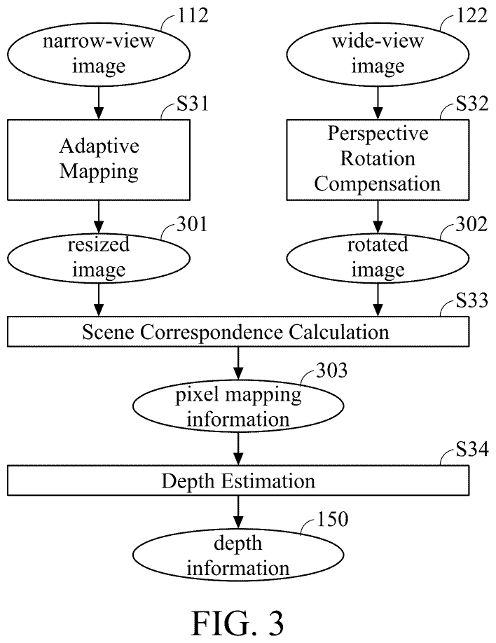

FIG. 3 is the flow diagram of the depth estimation method 30 executed by the depth estimation system 10 illustrated in FIG. 1, according to an embodiment of the present disclosure. As shown in FIG. 3, the depth estimation method 30 includes the Adaptive Mapping step S31, the Perspective Rotation Compensation step S32, the Scene Correspondence Calculation step S33, and the Depth Estimation step S34.

In the Adaptive Mapping step S31, the narrow-view image 112 is downscaled to generate a resized image 301. This step aims to harmonize the scale of the narrow-view image 112 with the wide-view image 122, facilitating the subsequent correspondence calculations.

In the Perspective Rotation Compensation step S32, the wide-view image 122 is rotated using a rotation compensation parameter to generate a rotated image 302. The rotation compensation parameter is determined based on the orientation deviation 22 between the pinhole camera 11 and the fisheye camera 12. The purpose of this step is to align the perspective of the wide-view image 122 with that of the narrow-view image 112, facilitating the subsequent correspondence calculations.

In the Scene Correspondence Calculation step S33, pixel mapping information between the rotated image 302 and the resized image 301 is determined based on an epipolar constraint. The epipolar constraint is a geometric property that establishes a relationship between corresponding points in two images captured by cameras with different viewpoints. It reduces the search space for pixel matching by imposing a restriction that corresponding points must lie along specific paths defined by the cameras' relative positioning. By leveraging the epipolar constraint, the Scene Correspondence Calculation step S33 identifies the correspondence between pixels in the resized image 301 and the rotated image 302, enabling the extraction of pixel mapping information 303 that serves as the foundation for depth estimation.

In the Depth Estimation step S34, depth information 150 of the entity 101 relative to the pinhole camera 11 is estimated based on the pixel mapping information 303 and the position offset 21. Specifically, the pixel mapping information identifies corresponding points between the two images, such as a pixel (uₖ, νₖ) in the resized image 301 and its counterpart (xₖ, yₖ) in the rotated image 302. The position offset 21 provides the spatial distance between the two cameras. Using the principles of similar triangles, the depth of the entity 101 relative to the pinhole camera 11 can be calculated by analyzing the geometric relationships between the corresponding pixel coordinates, the cameras' relative positions, and their intrinsic parameters such as focal lengths.

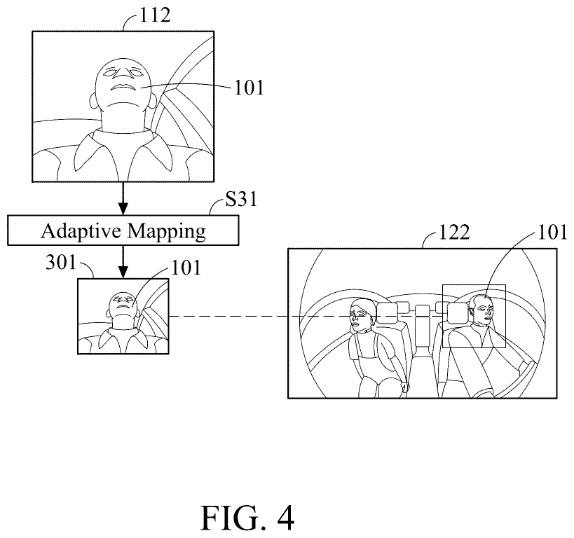

FIG. 4 is the schematic diagram illustrating operation of the Adaptive Mapping step S31, according to an embodiment of the present disclosure. As shown in FIG. 4, after the Adaptive Mapping step S31, the scale of the narrow-view image 112, hereinafter referred to as “the first scale,” is significantly reduced, generating the resized image 301 with the scale, hereinafter referred to as “the second scale,” which is substantially smaller than the first scale.

In a further embodiment, the second scale is determined based on a comparison of the size of the entity 101 in the wide-view image 122 and the size of the entity 101 in the narrow-view image 112. Consequently, the entity 101 in the wide-view image 122 and the entity 101 in the resized image 301 are substantially equal in size. For instance, the difference in the pixel area occupied by the entity 101 in the resized image 301 and that in the wide-view image 122 is within a specified threshold, such as 5%, ensuring that the relative size of the entity 101 in both images is sufficiently consistent for accurate correspondence calculations. This adjustment ensures that subsequent correspondence calculations between the resized image 301 and the rotated image 122 can be performed more efficiently and with improved accuracy, as the geometric differences caused by scale inconsistencies are minimized.

In another embodiment, the narrow-view image is downscaled using a scaling factor that is determined based on focal lengths of the pinhole camera 11 and the fisheye camera 12. Specifically, the scaling factor may be proportional to the ratio between the focal length of the fisheye camera 12 and the focal length of the pinhole camera 11. This ensures that the resized image 301 reflects the same relative proportions as the wide-view image 122 captured by the fisheye camera 12, facilitating consistent geometric alignment between the two images.

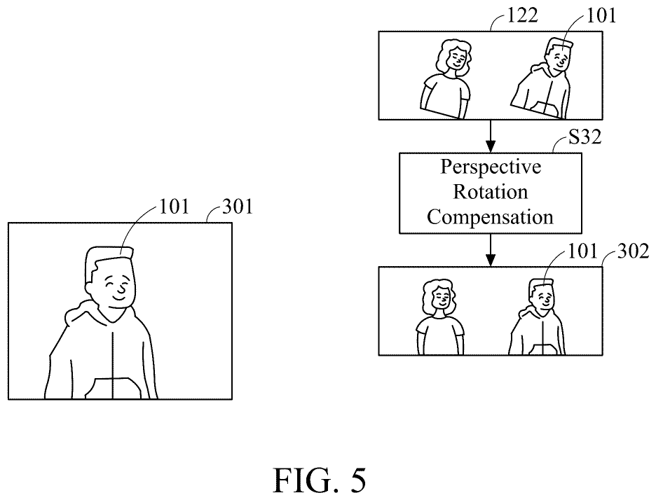

FIG. 5 is the schematic diagram illustrating operation of the Perspective Rotation Compensation step S32, according to an embodiment of the present disclosure. As shown in FIG. 5, due to the presence of the orientation deviation 22 between the pinhole camera 11 and the fisheye camera 12, the entity 101 in the wide-view image 122 appears with a different orientation and angular alignment compared to its representation in the resized image 301 (or the narrow-view image 112). This misalignment results in inconsistent geometric relationships for the same features of the entity 101, making feature matching more challenging. This issue is particularly pronounced in automotive applications, where objects, including the entity 101, are typically captured at close range, causing features to occupy a significant number of pixels. Any variation in orientation introduces noticeable inconsistencies that can significantly reduce the accuracy of feature correspondence.

After undergoing the Perspective Rotation Compensation step S32, the entity 101 in the rotated image 302 is corrected to a perspective that aligns with the resized image 301 (or the narrow-view image 112). This correction minimizes the rotational discrepancies and ensures that the features of the entity 101 are geometrically consistent across the two images, significantly improving the accuracy and efficiency of subsequent correspondence calculations.

As previously mentioned, the rotation compensation parameter used in the Perspective Rotation Compensation step S32 is determined based on the orientation deviation 22, which represents the relative extrinsic parameters of the pinhole camera 11 and the fisheye camera 12. The extrinsic parameters of the pinhole camera 11 and the fisheye camera 12 can be calibrated during an offline phase using standard calibration techniques. This calibration process allows the rotation compensation parameter to be precomputed and stored, eliminating the need for the processing circuitry 13 to perform complex calculations to derive the parameter during the online phase.

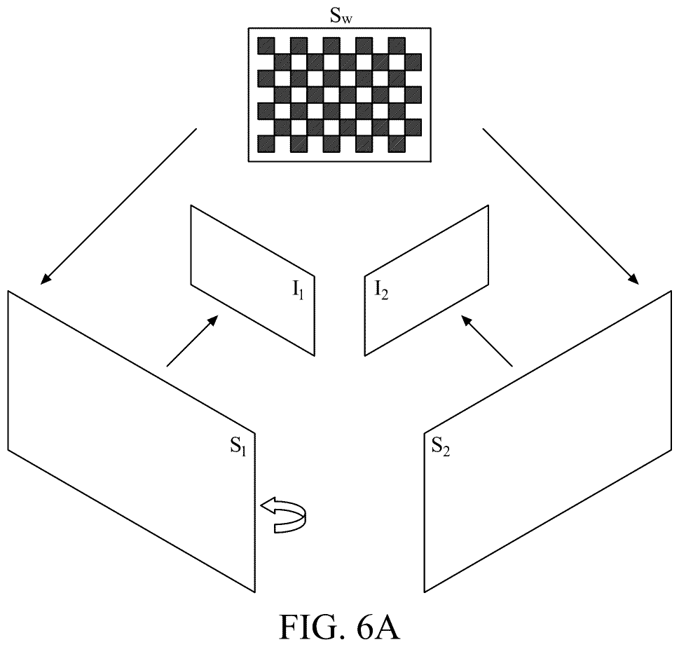

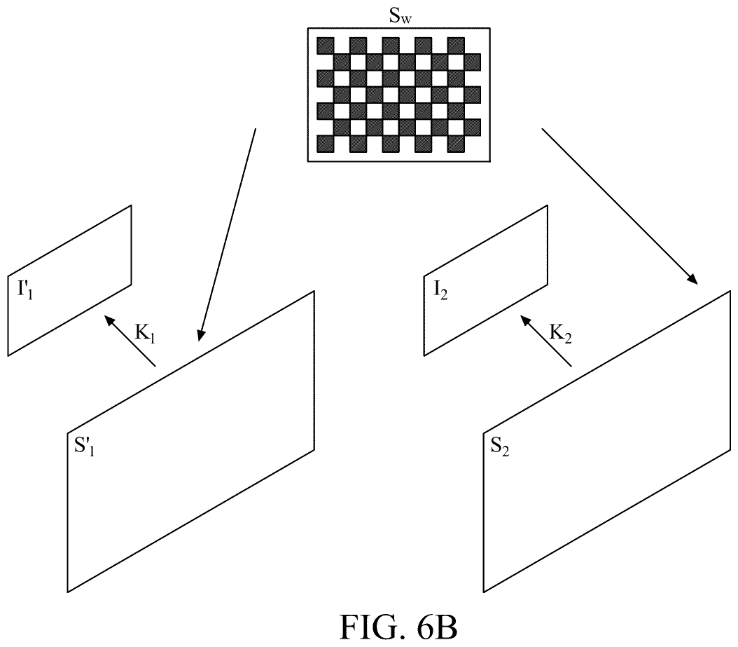

FIG. 6A and FIG. 6B illustrate the process of deriving the rotation compensation parameter during an offline calibration phase, according to an embodiment of the present disclosure. This parameter is later used in the online Perspective Rotation Compensation step S32 to correct the wide-view image 122.

As shown in FIG. 6A, a target plane S_{w} in the world coordinate system, such as a calibration board, is projected into the respective camera coordinate systems of the two cameras. The result of these projections is two camera-specific geometric planes, S₁ and S₂, which reflect the relative positions and orientations of the cameras. These planes are further transformed through the intrinsic parameters of the respective cameras, resulting in image planes I₁ and I₂. However, due to the orientation deviation between the two cameras, S₁ and S₂, as well as their respective image planes I₁ and I₂, are not geometrically aligned.

FIG. 6B demonstrates the geometric alignment achieved through the rotation compensation process. As shown, the plane S₁ is computationally adjusted during the offline calibration phase to produce a corrected plane S₁′, which is aligned with the plane S₂ in the second camera's coordinate system. This adjustment ensures that when S₁' is transformed through the intrinsic parameters of the first camera, the resulting image plane S₁′ becomes parallel to I₂, thereby resolving the misalignment shown in FIG. 6A.

The derived relationship, I₁′=K₁RK₁⁻¹I₁, where R denotes the orientation deviation, establishes the rotation compensation parameter K₁RK₁⁻¹. This derived rotation compensation parameter, precomputed during the calibration process, is subsequently applied in the online phase to align the perspectives of the images captured by the two cameras having the orientation deviation therebetween.

In conventional stereo camera pixel matching approaches, optical properties are used to correct epipolar lines corresponding to all pixels, ensuring that the same pixel from different viewpoints lies on the same horizontal line. This facilitates algorithmic search for pixel correspondences. In the embodiments of the present disclosure, however, due to the presence of the orientation deviation 22 between the pinhole camera 11 and the fisheye camera 12, applying the conventional epipolar line correction approach would result in a significant loss of features, hindering pixel matching. Therefore, a solution is proposed herein to leverage the pre-calibrated intrinsic and extrinsic parameters of the cameras, which can be obtained during the offline phase, to determine the relationship between pixel points across different viewpoints and their corresponding slanted epipolar lines. Matching pixels between the resized image 301 and the rotated image 302 are then identified along these slanted epipolar lines. This approach simplifies the traditional epipolar correction process while avoiding the problem of losing features caused by applying conventional correction algorithms to heterogeneous camera configurations.

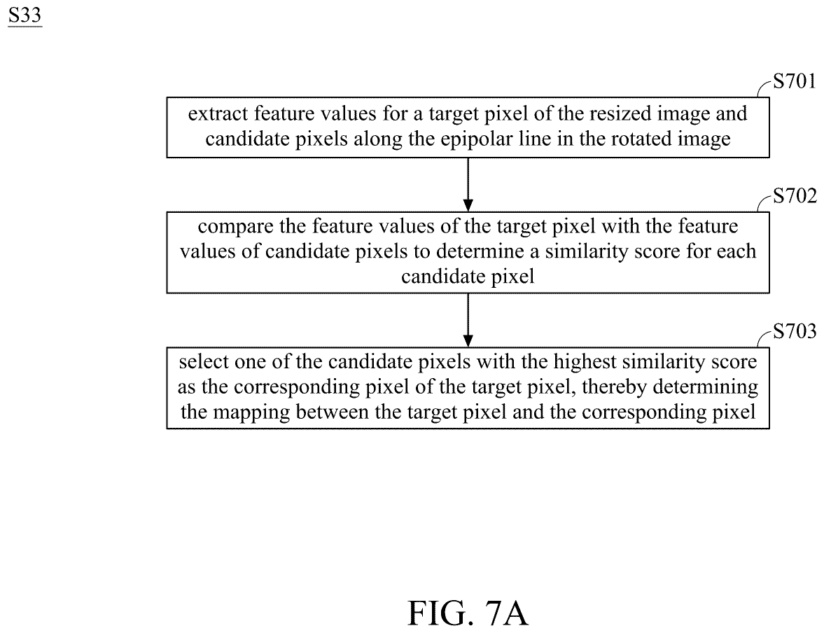

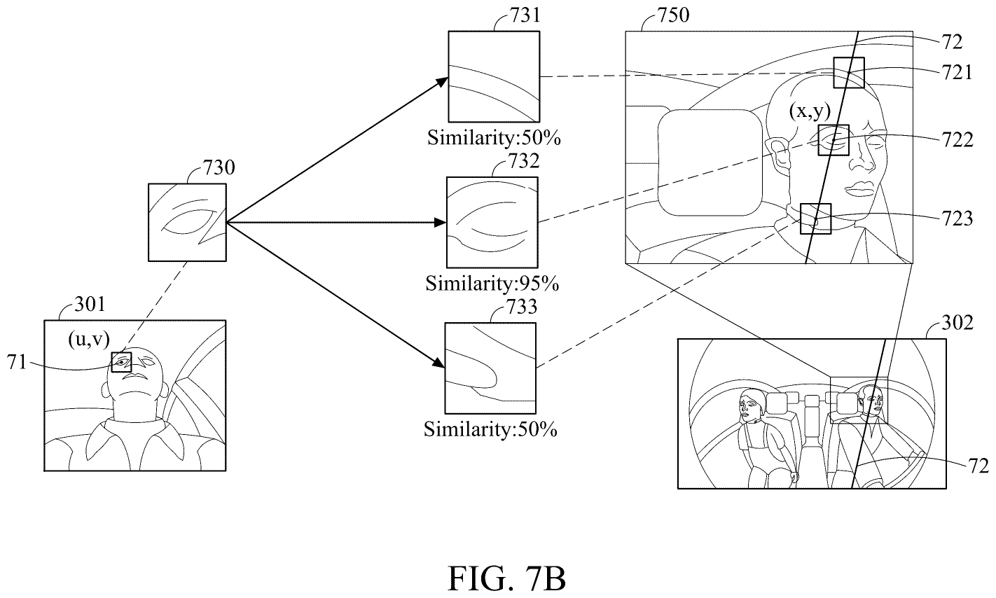

FIG. 7A is the flow diagram of the Scene Correspondence Calculation step S33, according to an embodiment of the present disclosure. In this embodiment, the epipolar constraint is defined by a coefficient set of an epipolar line, such as (a, b, c) for the straight line equation ax+by+c=0. As shown in FIG. 7A, the Scene Correspondence Calculation step S33 can further include more detailed steps S701-S703. FIG. 7B is the corresponding schematic diagram of the Scene Correspondence Calculation step S33. FIG. 7A and FIG. 7B can be jointly referenced for a better understanding of this embodiment.

In step S701, feature values are extracted for a target pixel of the resized image and candidate pixels along the epipolar line in the rotated image. The feature values are determined based on pixel intensity within a predefined neighborhood of each pixel, such as the average intensity, variance, or gradient magnitude computed within a 3×3 or 5×5 pixel window. In the example shown in FIG. 7B, feature values 730 are extracted for the target pixel 71 of the resized image 301. Meanwhile, feature values 731, 732, and 733 are extracted for the candidate pixels 721, 722, and 723, respectively, along the epipolar line 72 in the rotated image 302.

In step S702, the feature values of the target pixel and the candidate pixels are compared to determine their similarity. This comparison involves computing a similarity score using predefined metrics, such as normalized cross-correlation (NCC), mean squared error (MSE), or cosine similarity. As shown in FIG. 7B, the feature value 730 of the target pixel 71 is compared with the feature values 731, 732, and 733 of the candidate pixels 721, 722, and 723, respectively, along the epipolar line 72, to generate corresponding similarity scores.

In step S703, the candidate pixel with the highest similarity score is selected as the corresponding pixel of the target pixel, thereby determining the mapping between the target pixel and the corresponding pixel. This mapping establishes the correspondence between the two images, enabling further depth estimation calculations. As shown in FIG. 7B, among the candidate pixels 721, 722, and 723, the candidate pixel 722 is identified as the best match for the target pixel 71, based on having the highest similarity score.

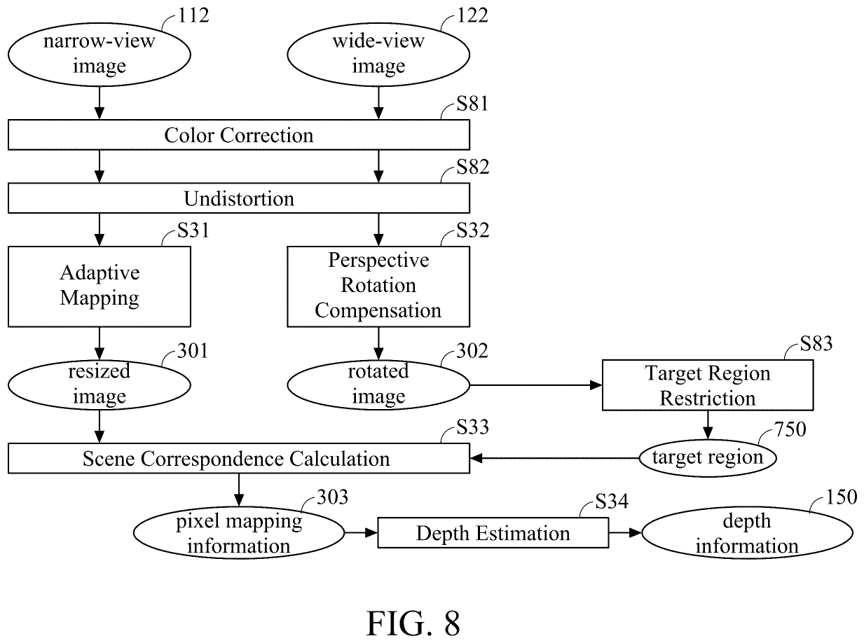

FIG. 8 illustrates additional steps S81, S82, and S83, any one or combination of which may be included in the depth estimation method 30 shown in FIG. 3, according to various embodiments of the present disclosure. These steps are detailed below.

In an embodiment, the depth estimation method 30 may further include a Color Correction step S81 before the Adaptive Mapping step S31 and the Perspective Rotation Compensation step S32. The Color Correction step S81 involves aligning the color tones of the narrow-view image 112 and the wide-view image 122 to reduce inconsistencies between the two images. This alignment can be achieved through several approaches, such as histogram matching, color balance adjustment, or white balance correction. By minimizing color discrepancies, the computational complexity of subsequent steps, such as Scene Correspondence Calculation step S33, can be significantly reduced. In an implementation, the color tones of the narrow-view image 112 and the wide-view image 122 may be aligned by converting both images to grayscale. This approach not only simplifies the color correction process but also standardizes the intensity values, making feature extraction and matching more efficient.

In a preferred alternative embodiment, the Color Correction step S81 is performed after the Adaptive Mapping step S31 and the Perspective Rotation Compensation step S32, rather than before them as depicted in FIG. 8. In other words, instead of aligning the color tones of the narrow-view image 112 and the wide-view image 122, the Color Correction step S81 is applied to the resized image 301 and the rotated image 302. By deferring the color adjustment to a later stage, more details are maintained for subsequent processing, thereby avoiding the loss of subtle variations in intensity and contrast, which could be beneficial for feature extraction and matching in the Scene Correspondence Calculation step S33.

In an embodiment, the depth estimation method 30 may further include an Undistortion step S82 before the Adaptive Mapping step S31 and the Perspective Rotation Compensation step S32. The Undistortion step S82 involves using a first distortion coefficient set and a second distortion coefficient set to correct distortions in the narrow-view image 112 and the wide-view image 122, respectively. The first distortion coefficient set corresponds to the pinhole camera 11 and typically includes parameters that describe radial and tangential distortions specific to the lens characteristics of the pinhole camera 11. The second distortion coefficient set corresponds to the fisheye camera 12 and accounts for the extreme radial distortion introduced by the fisheye lens. Correcting these distortions before the Adaptive Mapping step S31 and the Perspective Rotation Compensation step S32 ensures that the images are geometrically rectified, facilitating more accurate scene correspondence calculations in subsequent steps.

In an embodiment, the depth estimation method 30 may further include a Target Region Restriction step S83. The Target Region Restriction step S83 involves identifying a target region 750 in the rotated image 302, which is an area containing the facial region of the entity within the rotated image 302. As shown in FIG. 7B, the target region 750, containing the facial region of the entity 101, is identified in the rotated image 302. This Target Region Restriction step S83 enables the subsequent Scene Correspondence Calculation step S33 to focus solely on determining the pixel mapping information between the target region 750 and the resized image 301, without needing to process the entire rotated image 302, thereby improving computational efficiency.

The target region 750 can be identified during the online phase of the Target Region Restriction step S83 through object or facial recognition algorithms that compute a bounding box around the entity. Alternatively, the target region may be predefined during the offline phase as a fixed area, such as the overlapping field of view between the pinhole camera 11 and the fisheye camera 12. Moreover, both methods of identifying the target region 750 can be implemented concurrently, allowing the system to dynamically identify the target region during the online phase through real-time object or facial recognition algorithms, while simultaneously leveraging a predefined fixed area from the offline phase, such as the overlapping field of view between the pinhole and fisheye cameras. This dual approach ensures greater flexibility and accuracy in target region identification. In in-cabin applications, where the entity is typically the driver, the position of the entity tends to remain relatively stable. Therefore, the predefining of the target region during the offline phase can be particularly effective, reducing the need for real-time computations and further optimizing the overall system performance.

In some embodiments, the epipolar constraint is calculated during the online phase as part of the Scene Correspondence Calculation step S33. However, since the epipolar constraint for each pixel is determined solely based on camera parameters, such as the orientation deviation and position offset between the pinhole camera 11 and the fisheye camera 12, and not on the actual image content, it is possible to pre-calculate these constraints during the offline phase. Therefore, in some other embodiments, the epipolar constraint for each pixel of the resized image 301 is pre-calculated during the offline phase and stored in a mapping table. During the online phase, the Scene Correspondence Calculation step S33 retrieves the pre-computed epipolar constraint directly from the mapping table, significantly reducing computational overhead. Specifically, the epipolar constraint for each pixel of the resized image is determined based on the known orientation deviation and position offset, and this correspondence is recorded in the mapping table. By storing this mapping, the system avoids recalculating the epipolar constraints in real time, thereby streamlining the online phase.

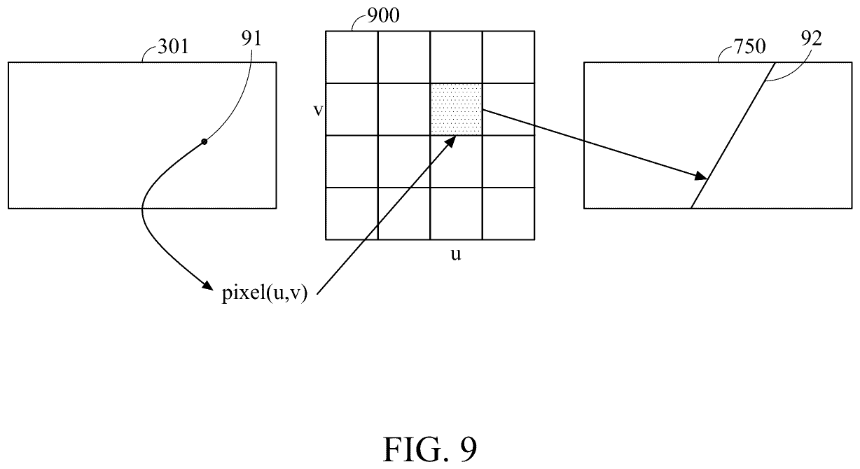

FIG. 9 is a schematic diagram of a mapping table 900, according to an embodiment of the present disclosure. As shown in FIG. 9, the mapping table 900 records the correspondence between each pixel of the resized image 301 and its associated epipolar constraint. For instance, pixel 91 at coordinates (u, v) in the resized image 301 corresponds to an epipolar line 92 in the target region 750 of the rotated image. This correspondence is pre-calculated and stored in the mapping table 900.

During the online phase, the Scene Correspondence Calculation step S33 retrieves the epipolar constraint for pixel 91 from the mapping table 900. The mapping table provides a coefficient set for the epipolar line 92, enabling the system to immediately use this information for feature extraction and pixel matching without needing to perform additional geometric calculations.

It should be noted that, although FIG. 9 demonstrates the correspondence for a single pixel 91, the mapping table 900 is designed to cover all pixels in the resized image 301, providing a complete lookup resource for epipolar constraints.

The pre-calculated mapping table 900 not only accelerates real-time processing but also enhances the consistency and reliability of the depth estimation process. This is especially beneficial in applications where computational efficiency is critical, such as in-cabin monitoring systems for depth estimation of an entity like a driver.

As illustrated in FIG. 8, the depth estimation method may include several steps, such as the Color Correction step S81, Undistortion step S82, Adaptive Mapping step S31, Perspective Rotation Compensation step S32, Target Region Restriction step S83, Scene Correspondence Calculation step S33, and the Depth Estimation step S34. With the sequential input of the narrow-view image sequence and the wide-view image sequence, these steps are iteratively executed. Additionally, each of these steps involves intermediate data that occupies memory blocks for processing. In the depth estimation system adopting a conventional memory allocation approach, the positions of memory blocks occupied by intermediate data generated in each step are not fixed, and the timing of memory block release after the completion of each step is also unpredictable. When the rate at which memory blocks are released fails to keep up with the processing demands of the depth estimation pipeline, a memory shortage may occur.

For instance, when the depth estimation pipeline reaches the Perspective Rotation Compensation step S32 for the k^{th} frame of the wide-view image 122 (a step that requires a relatively large amount of memory), a memory shortage may arise due to the memory blocks occupied by the Adaptive Mapping step S31 for the (k-1)^{th} frame of the narrow-view image sequence 112 not yet being released. This memory shortage can subsequently disrupt the pipeline's progression, potentially resulting in delayed processing or even system failure. To prevent such issues and ensure the smooth execution of the depth estimation pipeline, an optimized memory allocation strategy is proposed herein.

In an embodiment, the depth estimation system 10 further includes a volatile memory. Additionally, the Perspective Rotation Compensation step S32 is pre-allocated a contiguous section of the volatile memory during a preliminary phase. This contiguous section, hereinafter referred to as the first contiguous section of the volatile memory, consists of multiple consecutive memory blocks. The Perspective Rotation Compensation step S32 is assigned a pointer indicating the starting position of the first contiguous section of the volatile memory. Subsequently, the processing circuitry 13 initializes the first contiguous section of the volatile memory with a predefined value, such as 0 or −1, to clear any residual data from previous operations. Thus, during the online phase of the Perspective Rotation Compensation step S32, the pre-allocated first contiguous section of the volatile memory can be used to perform the rotation of the wide-view image 122 without concern for memory outage issues.

In further embodiments, besides the Perspective Rotation Compensation step S32, other steps in the depth estimation pipeline can also be pre-allocated corresponding memory spaces during the preliminary phase. Specifically, in the preliminary phase, a second contiguous section, a third contiguous section, and a fourth contiguous section of the volatile memory can be allocated for the Adaptive Mapping step S31, Scene Correspondence Calculation step S33, and the Depth Estimation step S34, respectively. Thus, in the online phase, the second contiguous section of the volatile memory can be used to downscale the narrow-view image 112, the third contiguous section can be used to determine the pixel mapping information, and the fourth contiguous section can be used to estimate the depth information 150, without concern for memory outage issues.

Similarly, other steps such as the Color Correction step S81, Undistortion step S82, and Target Region Restriction step S83 can also be allocated dedicated memory sections in the preliminary phase. By pre-allocating memory spaces for each step, the system minimizes runtime delays caused by dynamic memory allocation and ensures the smooth progression of the depth estimation pipeline. This approach not only enhances the overall efficiency of memory management but also reduces the risk of memory contention during the online phase.

It should be appreciated that the terms “first contiguous section,” “second contiguous section,” “third contiguous section,” and “fourth contiguous section” are used solely to distinguish between different allocated memory spaces and do not imply any specific order in physical arrangement or allocation sequence. These designations are merely for reference and clarity in describing how different steps in the depth estimation pipeline utilize distinct portions of the volatile memory.

In an alternative embodiment, the depth estimation system 10 further includes a volatile memory. To optimize memory management and prevent runtime allocation delays, the processing circuitry 13 is configured to pre-allocate a first contiguous section of the volatile memory during a preliminary phase. This first contiguous section, consisting of multiple consecutive memory blocks, is used as a buffer to temporarily store the wide-view image 122. Additionally, to ensure data integrity and prevent unintended residual effects from prior operations, the processing circuitry 13 initializes the first contiguous section of the volatile memory with a predefined value, such as 0 or −1. During the online phase, when a new wide-view image 122 is captured, the processing circuitry 13 stores it in the pre-allocated first contiguous section of the volatile memory. To perform image rotation, the processing circuitry 13 further uses a first separate section of the volatile memory to process the rotation operation independently. Once the rotation is completed, the rotated image is written back to the first contiguous section of the volatile memory, effectively overwriting the originally stored wide-view image 122.

In a further embodiment, during a preliminary phase, the processing circuitry 13 is configured to allocate a second contiguous section of the volatile memory. This second contiguous section, which consists of multiple consecutive memory blocks, is used as a buffer to temporarily store the narrow-view image 122. During the online phase, the processing circuitry 13 uses the allocated second contiguous section of the volatile memory to store the narrow-view image 112 upon capture. To perform downscaling, the processing circuitry 13 further uses a second separate section of the volatile memory to generate a resized image 301 from the stored narrow-view image 112. After the resizing operation is completed, the resized image 301 is written back to the second contiguous section of the volatile memory, effectively overwriting the original narrow-view image 112.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A depth estimation system, comprising:
a pinhole camera, configured to capture a narrow-view image of an entity;
a fisheye camera, configured to capture a wide-view image of the entity, wherein an orientation deviation and a position offset are present between the pinhole camera and the fisheye camera;
a processing circuitry, configured to:
downscale the narrow-view image to generate a resized image;
rotate the wide-view image using a rotation compensation parameter to generate a rotated image, wherein the rotation compensation parameter is determined based on the orientation deviation;
determine pixel mapping information between the rotated image and the resized image based on an epipolar constraint; and
estimate depth information of the entity relative to the pinhole camera based on the pixel mapping information and the position offset.

2. The depth estimation system as claimed in claim 1, wherein the epipolar constraint for each pixel of the resized image is determined based on the orientation deviation and the position offset, and is stored in a mapping table, wherein the mapping table records a correspondence between each pixel of the resized image and the epipolar constraint; and
wherein the processing circuitry is further configured to retrieve the epipolar constraint from the mapping table based on the correspondence recorded in the mapping table for each pixel of the resized image.

3. The depth estimation system as claimed in claim 1, wherein the epipolar constraint is defined by a coefficient set of an epipolar line; and
wherein the processing circuitry is further configured to determine the pixel mapping information between the rotated image and the resized image based on the epipolar constraint by:
extracting feature values for a target pixel of the resized image and a plurality of candidate pixels along the epipolar line in the rotated image, wherein the feature values are determined based on pixel intensity within a predefined neighborhood of each pixel;
comparing the feature values of the target pixel with the feature values of the plurality of candidate pixels to determine a similarity score for each candidate pixel; and
selecting one of the candidate pixels with a highest similarity score as a corresponding pixel of the target pixel, thereby determining a mapping between the target pixel and the corresponding pixel.

4. The depth estimation system as claimed in claim 1, wherein the processing circuitry is further configured to reduce a first scale of the narrow-view image to generate the resized image with a second scale that is substantially smaller than the first scale.

5. The depth estimation system as claimed in claim 4, wherein the second scale is determined based on a comparison of the size of the entity in the wide-view image and the size of the entity in the narrow-view image; and
wherein the entity in the wide-view image and the entity in the resized image are substantially equal in size.

6. The depth estimation system as claimed in claim 1, wherein the processing circuitry is further configured to downscale the narrow-view image using a scaling factor, wherein the scaling factor is determined based on focal lengths of the pinhole camera and the fisheye camera.

7. The depth estimation system as claimed in claim 1, further comprising a volatile memory, wherein the processing circuitry is further configured to:
in a preliminary phase, allocate a first contiguous section of the volatile memory, and initialize the first contiguous section of the volatile memory with a predefined value; and
in an online phase, use the first contiguous section of the volatile memory to rotate the wide-view image.

8. The depth estimation system as claimed in claim 7, wherein in the preliminary phase, the processing circuitry is further configured to allocate a second contiguous section, a third contiguous section, and a fourth contiguous section of the volatile memory; and
wherein in the online phase, the processing circuitry is further configured to:
use the second continuous section of the volatile memory to downscale the narrow-view image;
use the third continuous section of the volatile memory to determine the pixel mapping information; and
use the fourth continuous section of the volatile memory to estimate the depth information of the entity relative to the pinhole camera.

9. The depth estimation system as claimed in claim 1, further comprising a volatile memory, wherein the processing circuitry is further configured to:
in a preliminary phase, allocate a first contiguous section of the volatile memory, and initialize the first contiguous section of the volatile memory with a predefined value; and
in an online phase:
use the first contiguous section of the volatile memory to store the wide-view image;
use a first separate section of the volatile memory to rotate the wide-view image;
overwrite the wide-view image in the first contiguous section with the rotated image.

10. The depth estimation system as claimed in claim 9, wherein in the preliminary phase, the processing circuitry is further configured to allocate a second contiguous section of the volatile memory; and
wherein in the online phase, the processing circuitry is further configured to:
use the second contiguous section of the volatile memory to store the narrow-view image;
use a second separate section of the volatile memory to downscale the narrow-view image to generate a resized image; and
overwrite the narrow-view image in the second contiguous section with the resized image.

11. The depth estimation system as claimed in claim 1, wherein the processing circuitry is further configured to:
use a first distortion coefficient set to correct distortion in the narrow-view image before downscaling the narrow-view image; and
use a second distortion coefficient set to correct distortion in the wide-view image before rotating the wide-view image.

12. The depth estimation system as claimed in claim 1, wherein the processing circuitry is further configured to align color tones of the resized image and the rotated image by grayscaling the resized image and the rotated image.

13. The depth estimation system as claimed in claim 1, wherein the orientation deviation is represented in one of a Euler angles format and a quaternion format.

14. The depth estimation system as claimed in claim 1, wherein the processing circuitry is further configured to:
identify a target region in the rotated image, wherein the target region is an area containing a facial region of the entity within the rotated image; and
determine the pixel mapping information between the target region and the resized image based on the epipolar constraint.

15. The depth estimation system as claimed in claim 1, wherein the processing circuitry is further configured to:
use the estimated depth information of the entity relative to the pinhole camera to adjust an operational parameter of an automotive control system.

16. The depth estimation system as claimed in claim 14, wherein the automotive control system includes at least one of a eye tracking-based dashboard display system, a driver attention alert system, a steering wheel adjustment system, a seat position adjustment system, an air conditioning system, a heads-up display system, or an airbag deployment system.

17. A depth estimation method, executed by a processing circuitry to estimate depth information of an entity relative to a pinhole camera based on a narrow-view image and a wide-view image of an entity, wherein the narrow-view image and the wide-view image are respectively captured by the pinhole camera and a fisheye camera, and wherein an orientation deviation and a position offset are present between the pinhole camera and the fisheye camera, the method comprising following steps:
downscaling the narrow-view image to generate a resized image;
rotating the wide-view image using a rotation compensation parameter to generate a rotated image, wherein the rotation compensation parameter is determined based on the orientation deviation;
determining pixel mapping information between the rotated image and the resized image based on an epipolar constraint; and
estimating the depth information of the entity relative to the pinhole camera based on the pixel mapping information and the position offset.

18. The depth estimation method as claimed in claim 17, wherein the epipolar constraint for each pixel of the resized image is determined based on the orientation deviation and the position offset, and is stored in a mapping table, wherein the mapping table records a correspondence between each pixel of the resized image and the epipolar constraint; and
wherein the step of determining the pixel mapping information further comprises retrieving the epipolar constraint from the mapping table based on the correspondence recorded in the mapping table for each pixel of the resized image.

19. The depth estimation method as claimed in claim 17, wherein the epipolar constraint is defined by a coefficient set of an epipolar line; and
wherein the step of determining the pixel mapping information between the rotated image and the resized image based on the epipolar constraint further comprises:
extracting feature values for a target pixel of the resized image and a plurality of candidate pixels along the epipolar line in the rotated image, wherein the feature values are determined based on pixel intensity within a predefined neighborhood of each pixel;
comparing the feature values of the target pixel with the feature values of the plurality of candidate pixels to determine a similarity score for each candidate pixel; and
selecting one of the candidate pixels with a highest similarity score as a corresponding pixel of the target pixel, thereby determining a mapping between the target pixel and the corresponding pixel.

20. The depth estimation method as claimed in claim 17, wherein the step of downscaling the narrow-view image further comprises reducing a first scale of the narrow-view image to generate the resized image with a second scale that is substantially smaller than the first scale.

21. The depth estimation method as claimed in claim 20, wherein the second scale is determined based on a comparison of the size of the entity in the wide-view image and the size of the entity in the narrow-view image; and
wherein the entity in the wide-view image and the entity in the resized image are substantially equal in size.

22. The depth estimation method as claimed in claim 17, wherein the step of downscaling the narrow-view image further comprises using a scaling factor to downscale the narrow-view image, wherein the scaling factor is determined based on focal lengths of the pinhole camera and the fisheye camera.

23. The depth estimation method as claimed in claim 17, further comprising:
in a preliminary phase, allocating a first contiguous section of a volatile memory, and initialize the first contiguous section of the volatile memory with a predefined value; and
in an online phase, using the first contiguous section of the volatile memory to rotate the wide-view image.

24. The depth estimation method as claimed in claim 23, further comprising:
in the preliminary phase, allocating a second contiguous section, a third contiguous section, and a fourth contiguous section of the volatile memory; and
in the online phase, using the second continuous section of the volatile memory to downscale the narrow-view image, using the third continuous section of the volatile memory to determine the pixel mapping information, and using the fourth continuous section of the volatile memory to estimate the depth information of the entity relative to the pinhole camera.

25. The depth estimation method as claimed in claim 17, further comprising:
in a preliminary phase, allocating a first contiguous section of a volatile memory, and initializing the first contiguous section of the volatile memory with a predefined value; and
in an online phase:
using the first contiguous section of the volatile memory to store the wide-view image;
using a first separate section of the volatile memory to rotate the wide-view image;
overwriting the wide-view image in the first contiguous section with the rotated image.

26. The depth estimation method as claimed in claim 25, further comprising:
in the preliminary phase, allocating a second contiguous section of the volatile memory;
in the online phase:
using the second contiguous section of the volatile memory to store the narrow-view image;
using a second separate section of the volatile memory to downscale the narrow-view image to generate a resized image; and
overwriting the narrow-view image in the second contiguous section with the resized image.

27. The depth estimation method as claimed in claim 17, further comprising:
using a first distortion coefficient set to correct distortion in the narrow-view image before downscaling the narrow-view image; and
using a second distortion coefficient set to correct distortion in the wide-view image before rotating the wide-view image.

28. The depth estimation method as claimed in claim 17, further comprising:
aligning color tones of the resized image and the rotated image by grayscaling the resized image and the rotated image.

29. The depth estimation method as claimed in claim 17, wherein the orientation deviation is represented in one of a Euler angles format and a quaternion format.

30. The depth estimation method as claimed in claim 17, further comprising:
identifying a target region in the rotated image, wherein the target region is an area containing a facial region of the entity within the rotated image; and
determining the pixel mapping information between the target region and the resized image based on the epipolar constraint.

31. The depth estimation method as claimed in claim 17, further comprising:
using the estimated depth information of the entity relative to the pinhole camera to adjust an operational parameter of an automotive control system.

32. The depth estimation method as claimed in claim 31, wherein the automotive control system includes at least one of an eye tracking-based dashboard display system, a driver attention alert system, a steering wheel adjustment system, a seat position adjustment system, an air conditioning system, a heads-up display system, or an airbag deployment system.
